(19) United States
(12) Patent Application Publication
(10) Pub. No.: US 2008/0281955 A1
(43) Pub. Date: Nov. 13, 2008

(54) Method and System for Operating Redundant Network Elements in a Communication Network

(76) Inventors: Giovanni Laghi, Mering (DE); Johannes Prade, Dingolfing (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/886,238

(22) PCT Filed: Feb. 16, 2006
(86) PCT No.: PCT/EP2006/060005

§ 371 Date: Sep. 13, 2007

(30) Foreign Application Priority Data
Mar. 17, 2005 (EP) 05102094.9

(51) Int. Cl. G06F 15/16

(52) U.S. Cl. 709/223

(57) ABSTRACT

An operation of redundant network elements in a communication network having a back-up-network element associated with each active-network element is provided. A back-up control unit is associated with each back-up-network element, and data sent to the active-network element is sent to the back-up network element. Data is processed separately by the active-network element and by the back-up-network element. Data traffic emitted by the back-up-network element is blocked by the back-up-control unit and the back-up-network element simulates the reaction of the other network elements. The back-up-control unit monitors the active-network element and switches to the back-up-network element in the event of a failure of the active-network element. The databases are created in the active-network element and in the back-up-network element in a parallel and faultless manner due to the introduction of the back-up-control unit. In the event of error, an automatic switchover may be carried out without a long delay time.

### CROSS REFERENCE TO RELATED APPLICATIONS

This application is the US National Stage of International Application No. PCT/EP2006/060005, filed Feb. 16, 2006 and claims the benefit thereof. The International Application claims the benefits of European Patent Office application No. 05102094.9 EP filed Mar. 17, 2005, both of the applications are incorporated by reference herein in their entirety.

### FIELD OF INVENTION

The invention relates to a method and a system for operating redundant network elements in a communication network, with a back-up network element being assigned to each active network element.

### BACKGROUND OF INVENTION

By definition, a communication network is understood as the preamble for all resources, by means of which network access points which are remote from one another are connected and by means of which services with service features are made available for communication purposes.

Communication networks are for instance:
telecommunication networks, which are configured as circuit-switching networks
packet-oriented networks such as for instance data networks or special IP networks, which use the internet protocol, also abbreviated to IP, for communication purposes.

Communication networks typically comprise a plurality of network elements such as for instance switching centers as well as soft switches, routers or gateways. The network elements are connected to one another by means of physical connections, which form the communication paths for data. The communication paths are used by the network elements to exchange data with other network elements for instance.

To ensure that the data is transmitted to the correct network element, each network element in a communication network is provided with a network address, by means of which a clear, logical identification of the network element is performed and by means of which the network element can be clearly identified within the communication network. If data is transmitted to a specific network element with the aid of the network address, the network address of the network element is also referred to as a target address (for the data), because the network element is the target for this data.

Since the highest possible availability is mostly required for communication networks, and since the communication network or parts thereof can be paralyzed by a failure or a destruction of individual network elements, network elements are often configured redundantly. This means that additional network elements are provided in the communication network by way of the assumed data traffic load, said network elements being useable in the case of failures or faults. Redundancy of an active network element in the communication network thus generally means that a second network element, so-called back-up element, is assigned to this active network element.

This back-up network element is to a large extent identical to the active network element in terms of design and configuration. Furthermore, it must be ensured that the active network element and the back-up network element have the same database, so that the back-up element can be used in the case of a failure or destruction of the active network element.

A network element, which is, in particular, frequently designed to be fail-safe, is a so-called media gateway controller. The media gateway controller is used in communication networks for the transition from conventional telecommunication networks to IP networks. The media gateway controller is frequently connected to the communication network by means of a so-called edge router. The edge router assumes the special task of converting media gateway controller data into data which can be transmitted in the communication network.

### SUMMARY OF INVENTION

In the case of approaches known from the prior art for the realization of redundantly configured network elements, a fail-safe (redundant) database is mostly used, with which the data of the active network element is mirrored in the back-up network element. This means that the databases from the active network element and from the back-up network element either have to be continuously aligned or always aligned at a specific time instant, so that they are consistent.

A continuous, (so-called synchronous) alignment of the databases results in the problem that the data transmission performance of the network elements deteriorates, since a part of the computing power has to be expended for this alignment process. If the alignment of the databases is only ever carried out at a certain time instant, such as once per day for instance, data losses can result, if in the event of the active network element failing, a switchover to the back-up network element is performed, since any data which has been stored between the last alignment process and the failure of the active network element on the active network element is not stored on the back-up network element.

The publication EP 1 489 778 A1 discloses a method for increasing the fail-safety of communication networks, with which the activities of a failed network element are assumed by a substitute network element by the transition into another operating mode, such as for instance standby to active, with this transition possibly lasting up to two hours for instance. This means that this time is taken up by the switchover from the failed to the substitute network element and in the meantime no data traffic is possible over this network element. As both network elements in the communication network are used in different operating modes in the method described in publication EP 1 489 778 A1, a daily update of the database is necessary for instance. Furthermore, with this method a problem similarly arises that changes to the databases introduced during the updating interval are lost during the switchover to the substitute network element.

The object underlying the present invention is to specify a method and system, by means of which the database of the back-up network element is kept consistent with that of the active network element without the need for an extensive data comparison, and by means of which a short switchover time is enabled between the active network element and the associated back-up network element.

This object is achieved in accordance with the invention by a method for operating redundant network elements in a communication network, with a back-up network element being assigned to each active network element, with which a back-up control unit is provided for each back-up network element, data which is transmitted to the active network element being sent in parallel to the back-up network element too, this data being processed separately by the active network element and the back-up network element and the data traffic emitted by the back-up network element being blocked by the back-up control unit, with the reaction of the other network elements being simulated however.

The advantages achieved with the invention consist in particular in databases being built up in the active and back-up network element in parallel by introducing the back-up control unit, without an extensive alignment of the data bases being necessary. In the case of the back-up network element, a fault-free configuration of the database is possible by means of the back-up control unit, which simulates the reactions of the other network elements. This enables a seamless transition from the active network element to the back-up element. This method is also advantageous in that it does not present any restriction in terms of the geographical distance between the active network element and the associated back-up network element.

A preferred development of the method according to the invention provides that the active network element is monitored by the back-up control unit and in the case of its failure or destruction, the data traffic from the back-up network element to the communication network is automatically generated and an automatic switchover from the active network element to the backup network element is performed. This allows the failure of a network element to be recognized as quickly as possible, as short a switchover time as possible to the back-up network element to be achieved and a lengthy failure in the communication network to be prevented.

It is favorable if different network addresses are assigned to the active network element and the associated back-up network element. The failure of a network element herewith results in a reconfiguration of another network element being avoided, such as for instance in the case of routers in the communication network, since the back-up network element is already registered in the communication network with its own network address and is connected to the communication network by way of the back-up control unit, by which only the data traffic emitted by the back-up element is blocked.

It is advantageous if the internet protocol and an IP network are provided for the communication between the active network element and the back-up element, because in an IP network, the communication paths from the other network elements to the active network elements, such as to the back-up network element, can already be set up. The active and/or the back-up network element are then addressed in a simple manner by way of its respective network address. Furthermore, the active network element can be monitored in a simple manner by the back-up control unit by means of message exchange.

The active network element is expediently connected by way of a first edge router and the back-up control unit of the back-up element is connected by way of a second edge router. The use of redundant edge routers enables a greater geographic distance between the active and back-up network element,

In a particularly preferred exemplary embodiment, a media gateway controller is provided as an active element and as an associated back-up network element in each instance, since this is used in communication networks for the transition from conventional telecommunication networks to IP networks.

This object is also achieved by means of a system of the type mentioned at the start, with a back-up network element being provided for an active network element and with a back-up control unit for simulating the data traffic between the back-up network element and the other network elements being provided in a communication network to the back-up network element in order to monitor the active network element and to switch over to the back-up network element in the event of a failure or deterioration in the active network element.

The system according to the invention is advantageous in that the back-up element, which is provided for the active network element, increases the fail-safety and thus the availability of the overall communication network. The introduction of the back-up control unit allows the databases in the active and in the back-up network element to be built up in parallel, without an extensive alignment of the databases being necessary. In addition, the simulation of the reactions of the other network elements by means of the back-up control unit allows the database of the back-up network element to be developed in a fault-free manner and enables a seamless transition from the active network element to the back-up element. Furthermore, a rapid switchover to the back-up network element is possible in the event that the active network element fails, since the back-up control unit monitors the active network element and performs the switchover.

In addition, it can also be advantageous if the active network element is entered as a first target address and the associated back-up network element is entered as a second target address for other network elements in the communication network, since both network elements in the communication network are known. This can be addressed by way of the respective target address. In the event that the active network element fails, the target address of the back-up network element is available and an extensive reconfiguration of the communication network is no longer necessary.

### BRIEF DESCRIPTION OF THE DRAWINGS

The invention is described by way of example in more detail below, with reference to the figures, in which;

FIG. 1. shows the functional setup of the system according to the invention for the operation of a redundant network element “media gateway controller” in a communication network, in which the method according to the invention is used

FIG. 2 shows the schematic sequence of the method according to the invention in the event that the active network element “media gateway controller” fails.

### DETAILED DESCRIPTION OF INVENTION

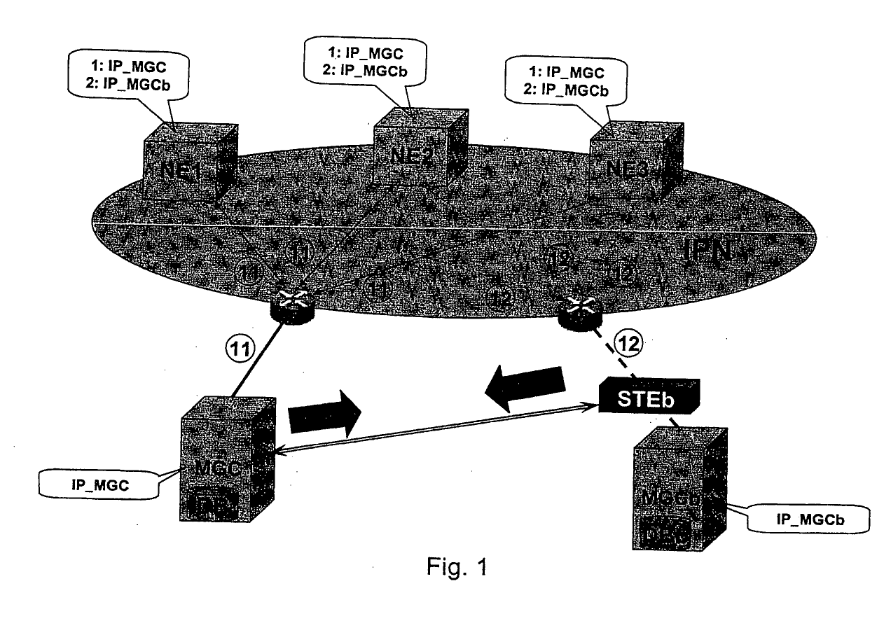

FIG. 1 shows an IP network used for communication purposes as a communication network IPN, which, in addition to another network element NE1, NE2, NE3, comprises a redundantly configured network element “media gateway controller” MGC. A back-up network element MGCb, likewise a media gateway controller, is assigned to the network element MGC. The active network element MGC and the back-up network element MGCb comprise to a large extent the same hardware and software modules and databases DB, DBb and are both operated in the active operating mode. Different network addresses IP_MGC and IP_MGCb are however assigned to the active network element MCC and the back-up network element MGCb in the communication network IPN.

The active network element MGC is connected to the communication network IPN by way of an edge router ER1. The communication with the other network elements NE1, NE2, NE3 of the communication network IPN is carried out by way of a communication path 11. Data is received from the network element MGC by way of this communication path 11, said data being sent from the other network elements NE1, NE2, NE3 to the network element MGC. This data is processed by the network element MGC and is stored in its database DB.

The associated back-up network element MGCb is likewise connected to the communication network IPN by way of an edge router ER2 and a communication path 12, with a back-up control unit STEb which is associated with the back-up network element being inserted between the edge router ER2 and the back-up network element MGCb. All data which is sent from the other network elements NE1, NE2, NE3 to the active network element MGC by way of the communication path 11 is also transmitted in parallel to the back-up network element MGCb by way of the communication path 12. The data is likewise processed by the back-up network element MGCb, with the data traffic transmitted by the back-up network element MGCb to the communication network IPN being blocked by the back-up control unit STEb. To ensure that the data which is stored in the database DB of the active network element MGC can be stored in the same manner in the database DBb of the back-up network element MGCb, the reactions of the other network elements NE1, NE2, NE3 are simulated by the back-up control unit STEb to the back-up network element MGCb. In addition, the active network element MGC is monitored by means of messages NA transmitted by the back-up control unit STEb. Active network element MGC responds with a response message AN.

To monitor the active network element MGC, a message NA is transmitted from the back-up control unit STEb of the back-up network element MGCbv in a first step 1 to the active network element MGC. If the active network element MGC has failed or been destroyed for instance, the back-up control unit STEb does not receive the expected response message AN in a second step 2. The blocking of the data traffic by the back-up network element MGCb to the communication network IPN, and thus to the other network elements NE1, NE2, NE3, is cancelled in a third step 3 by way of the edge router ER2 and the communication path 12. The function of the active network element MGC is thus taken on by the back-up element MGCb in a fourth step 4. As the network address IP_MGCb is stored as a second target address in the network elements NE1, NE2, NE3 of the communication network IPN, data is automatically sent by the other network elements NE1, NE2, NE3 in a fifth step to the back-up network element, if the connection to the network element MGC by way of the network address IP_MGC, which has been entered as the first target address, fails.

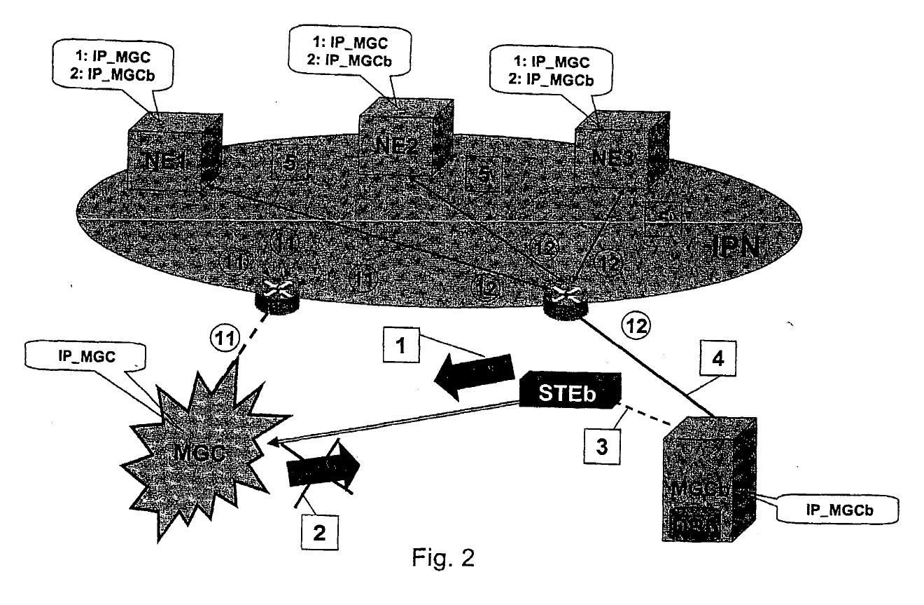

The system shown by way of example in FIG. 1 for a network element “media gateway controller” MGC and the associated back-up network element MGCb for operating redundant network elements as well as the method according to the invention as illustrated in FIG. 2 can be similarly used for every other network element NE1, NE2, NE3 in any communication network IPN, provided that the network element NE1, NE2, NE3 is configured redundantly. The same procedure applies here in principle.

1.-8. (canceled)

9. A method for operating redundant network elements in a communication network, comprising:
assigning a backup network element to each active network element;
providing a backup control unit for each backup network element;
transmitting data to the active network element and in parallel to the backup network element;
processing the data by the active network element;
processing the data by the backup network element;
blocking transmission from the backup network element to a further element of the communication network, the blocking by the backup control unit; and
simulating a response of the blocked transmission to the backup network element.

10. The method as claimed in claim 9, further comprising:
monitoring the active network element by the backup control unit of the backup network element;
recognizing a failure of the active network element by the backup control unit;
automatically generating by the backup control unit the response of the blocked transmission in order to simulate the response; and
changing over from the active network element to the backup network element in response to a failure of failure.

11. The method as claimed in claim 9, wherein a failure is a destruction of the active network element.

12. The method as claimed in claim 9, wherein different network addresses are assigned to the active network element and the associated backup network element.

13. The method as claimed in claim 12, wherein the active network element and the backup control unit of the backup network element are connected to an Internet protocol network provided for communication purposes via a first edge router and via a second Edge router respectively.

14. The method as claimed in claim 9, wherein the Internet protocol and an Internet protocol network are provided between the active network element and the backup network element for communication purposes.

15. The method as claimed in claim 14, wherein the active network element and the backup control unit of the backup network element are connected to an Internet protocol network provided for communication purposes via a first edge router and via a second Edge router respectively.

16. The method as claimed in claim 9, wherein a Media Gateway Controller is provided as the active network element and a Media Gateway Controller is provided as the associated backup network element.

17. A communication system with redundancy, comprising:
a first network element;
an active network element;
a backup network element assigned to the active network element;
a backup control unit that
simulates the data traffic from the first network element to the backup network element,
monitors the active network for a failure, and
performs a changeover to the backup network element in the event of a failure;
a first communication path between the first network element and the active network element; and
a second communication path between the first network element and the backup network element,
wherein data is transmitted in parallel from the first network element to the active network element via the first communication path and from the first network element to the backup network element via the second communication path, and
wherein the first network element and the active network element separately process the transmitted data.

18. The system as claimed in claim 17, wherein the first network element includes a first target address for the active network element and a second target address for the associated backup network element.

19. The system as claimed in claim 17, wherein a failure is a destruction of the active network element.
